(19) United States
(12) Patent Application Publication
(10) Pub. No.: US 2011/0223085 A1
(43) Pub. Date: Sep. 15, 2011

(54) CARBON DIOXIDE CAPTURE WITH IONIC LIQUID ELECTROSPRAY

(75) Inventors: MANISH S. KELKAR, WILMINGTON, DE (US); MARK A. SCIALDONE, WEST GROVE, PA (US); MARK BRANDON SHIFLETT, WILMINGTON, DE (US)

(73) Assignee: E. I. DU PONT DE NEMOURS AND COMPANY, Wilmington, DE (US)

(21) Appl. No.: 13/044,782

(22) Filed: Mar. 10, 2011

Related U.S. Application Data
(60) Provisional application No. 61/313,322, filed on Mar. 12, 2010.
(60) Provisional application No. 61/313,298, filed on Mar. 12, 2010.
(60) Provisional application No. 61/414,532, filed on Nov. 17, 2010.
(60) Provisional application No. 61/313,173, filed on Mar. 12, 2010.
(60) Provisional application No. 61/313,181, filed on Mar. 12, 2010.
(60) Provisional application No. 61/313,328, filed on Mar. 12, 2010.
(60) Provisional application No. 61/313,312, filed on Mar. 12, 2010.
(60) Provisional application No. 61/313,183, filed on Jun. 3, 2010.
(60) Provisional application No. 61/313,191, filed on Mar. 12, 2010.

(51) Int. Cl. B01D 53/62; B01D 53/50

(52) U.S. Cl. 423/228

(57) ABSTRACT

A method for capturing carbon dioxide and/or sulfur dioxide from a gaseous mixture using ionic liquid electrospray is described. In the method, the gaseous mixture is exposed to an ionic liquid electrospray plume comprising nanodroplets of an ionic liquid and the carbon dioxide and/or sulfur dioxide present in the gaseous mixture is absorbed by the ionic liquid nanodroplets. The ionic liquid electrospray plume is formed by applying an electric field between an electrospray nozzle and a counter electrode.

This application claims priority under 35 U.S.C. §119(e) from, and claims the benefit of, U.S. Provisional Application No. 61/313,322, filed Mar. 12, 2010, which is by this reference incorporated in its entirety as a part hereof for all purposes.

### TECHNICAL FIELD

The invention relates to the field of carbon dioxide and/or sulfur dioxide capture. More specifically, the invention relates to a method for capturing carbon dioxide and/or sulfur dioxide emissions from flue gas using electrospray nanodroplets of ionic liquids.

### BACKGROUND

Development of economically viable carbon dioxide (CO₂) capture processes is becoming increasingly important as concerns over greenhouse gas emissions continue to receive worldwide attention. The need for affordable post-combustion CO₂ capture processes for existing coal-fired power plants is of particular interest in the United States because these plants generate approximately 50% of the nation's electricity and produce about 30% of the CO₂ emissions.

Several different approaches have been proposed to remove CO₂ from post-combustion flue gases on a large scale, including cryogenic distillation, purification with membranes, absorption with liquids, and adsorption with solids. The concentration of CO₂ from post-combustion flue gas varies with fuel source, boiler age and design. Modern coal-fired boilers produce a flue gas which contains approximately 12 to 14% CO₂ by volume. In order to efficiently capture the CO₂ at this low concentration, chemical sorption is required. Currently, amine-based scrubbing is the most feasible technology for post-combustion CO₂ capture that is commercially deployable at required scales. A variety of amines have been studied which chemically react with CO₂, such as monoethanolamine (MEA). Additives to improve the reaction kinetics, such as piperazine, have also been studied. The primary thermodynamic limitation with amine-based scrubbers is the energy required to decompose the carbamate product at high temperatures (i.e., 373 to 393° K) during regeneration.

Gu et al. (U.S. Patent Application Publication No. 2009/0235817) describe an ionic liquid electrospray air scrubber for air cleaning applications, which uses charged ionic liquid nanodroplets formed through an electrospray process to capture air contaminants. However, the method has not been applied to CO₂ capture from flue gas.

Therefore, the need exists for a method for capturing carbon dioxide from flue gas which requires less energy than the current amine-based scrubbing methods.

### SUMMARY

The present invention addresses the stated need by providing a method for capturing carbon dioxide and/or sulfur dioxide emissions from a gaseous mixture using electrospray nanodroplets of ionic liquids.

Accordingly, in one embodiment the invention provides a method

for capturing carbon dioxide and/or sulfur dioxide from a gaseous mixture comprising the steps of:
a) providing a gasesous mixture comprising carbon dioxide and/or sulfur dioxide;
b) forming an ionic liquid electrospray plume comprising nanodroplets of at least one ionic liquid by
passing the ionic liquid through an electrospray nozzle and applying an electric field between the electrospray nozzle and a counter electrode;
c) exposing the gaseous mixture to the ionic liquid electrospray plume, whereby at least a portion of the carbon dioxide and/or sulfur dioxide is absorbed by the nanodroplets of the ionic liquid; and
d) collecting the nanodroplets of the ionic liquid containing absorbed carbon dioxide and/or sulfur dioxide on the counter electrode;

wherein said ionic liquid comprises an anion and a cation, said cation is selected from the group consisting of cations represented by the structures of the following formulae:

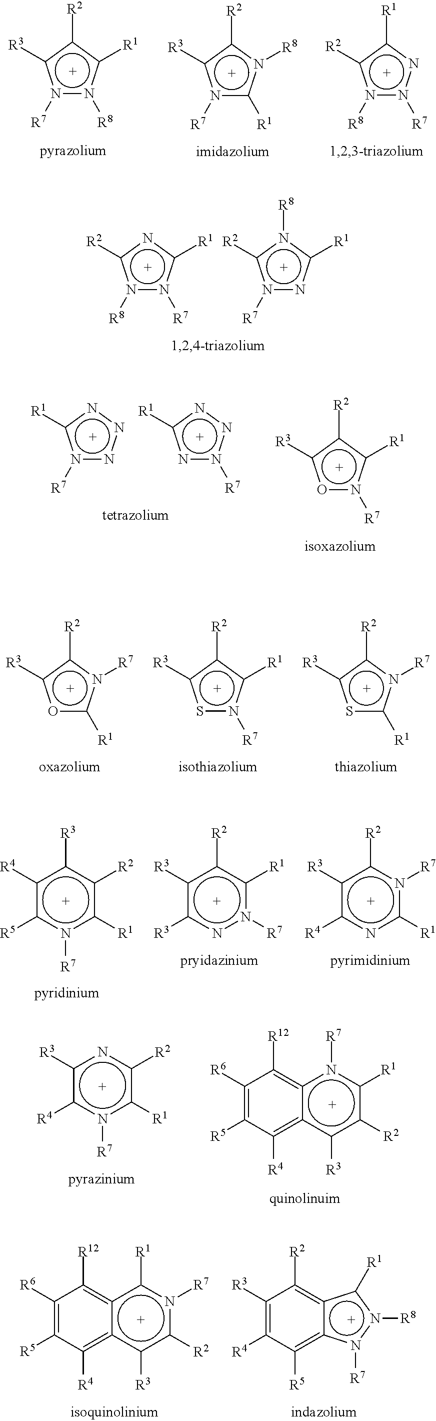

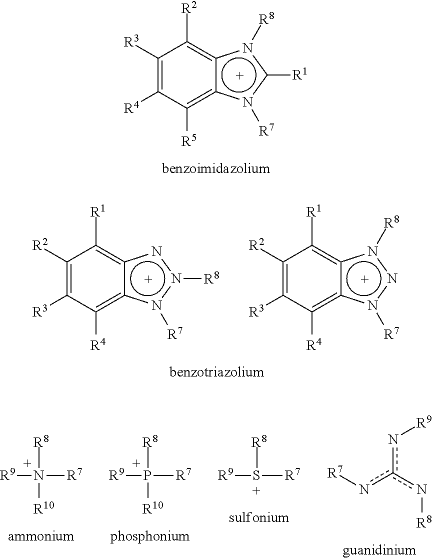

wherein:

a) R⁴, R², R³, R⁴, R⁵, R⁶, and R¹² are independently selected from the group consisting of:
(i) H,
(ii) halogen such as Cl, Br, F, I,
(iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to C₂₀ unsubstituted aryl, or C₆ to C₂₅ unsubstituted heteroaryl having one to three heteroatoms independently selected from the group consisting of O, N, Si and S;
(vi) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (A) —CH₃, —C₂H₅, or C₄ to C₂₅ straight-chain, branched or cyclic alkane or alkene, optionally substituted with at least one member selected from the group consisting of Cl, Br, F, I, OH, NH₂ and SH,
   (B) OH,
   (C) NH₂, and
   (D) SH;
(vii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
(viii)

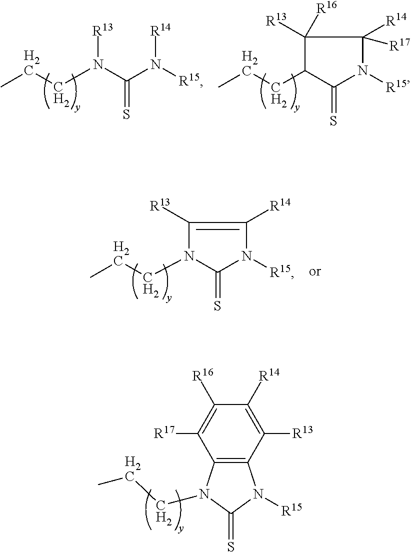

wherein y is 0-15, and R¹³, R¹⁴, R¹⁵, R¹⁶, and R¹⁷ are independently selected from the group consisting of: (i), (iii), (iv), (v), (vi) and (vii) as set forth above;

b) R⁷, R⁸, R⁹, and R¹⁸ are independently selected from the group consisting of:
(ix) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(x) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(xi) C₆ to C₂₅ unsubstituted aryl, or C₆ to C₂₅ unsubstituted heteroaryl having one to three heteroatoms independently selected from the group consisting of O, N, Si and S; and
(xii) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (E) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
   (F) OH,
   (G) NH₂, and
   (H)SH;
(xiii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
(xiv)

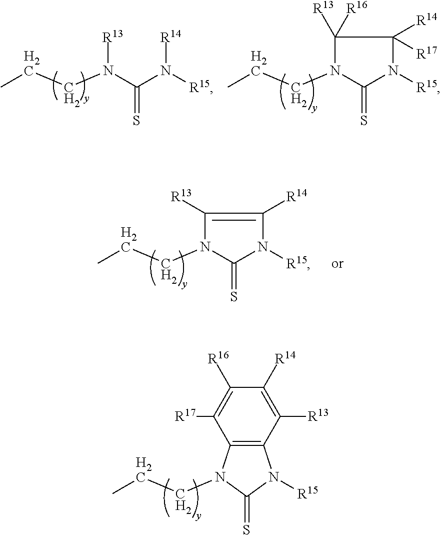

wherein y is 0-15, and R¹³, R¹⁴, R¹⁵, R¹⁶, and R¹⁷ are independently selected from the group consisting of: (i), (iii), (iv), (v), (vi) and (vii) as set forth above; and

c) optionally at least two of R¹, R², R³, R⁴, R⁵, R⁶, R⁷, R⁸, R⁹, and R¹⁰ can together form a cyclic or bicyclic alkanyl or alkenyl group.

### BRIEF DESCRIPTION OF THE DRAWING

FIG. 1 is a flow diagram of an exemplary system for use in the capture of carbon dioxide from flue gas using the method described herein.

### DETAILED DESCRIPTION

As used above and throughout the description of the invention, the following terms, unless otherwise indicated, shall be defined as follows:

The term “ionic liquid” refers to an organic salt that is fluid at or below about 100° C.

The term “flue gas”, as used herein, refers to the combustion exhaust gas produced by power plants, particularly coal-fired power plants.

The term “ionic liquid electrospray plume” refers to a hyperbolic cone comprising nanodroplets of an ionic liquid formed by applying a high voltage between an ionic liquid housed in an electrospray nozzle and a counter electrode.

The term “nanodroplets”, as used herein, refers to droplets of an ionic liquid having a diameter of about 100 nanometers to about 1000 nanometers.

The term “DC” means direct current.

The term “AC” means alternating current.

The term “Hz” means hertz (i.e., sec⁻¹).

Disclosed herein is a method for capturing carbon dioxide and/or sulfur dioxide emissions from a gaseous mixture such as a flue gas using electrospray nanodroplets of ionic liquids. The gases and gaseous mixtures referred to herein may include vapors (volatilized liquids), gaseous compounds and/or other gaseous elements. The method is useful for reducing carbon dioxide and/or sulfur dioxide emissions from power plant exhaust gas. The ionic liquid electrospray method disclosed herein offers several advantages including, but not limited to (1) a wide spectrum of ionic liquids or ionic liquid formulations that allow capture of CO₂; (2) greater than 90% capturing efficiency of CO₂ from flue gas using minimal amounts of ionic liquid; (3) an expected 10 to 100-fold power efficiency in a lighter and smaller scrubber; (4) the ability to recycle the ionic liquid or ionic liquid formulations; and (5) the ability to easily turn up and down the CO₂ scrubbing capacity with operational load variations (i.e. changes in flue gas flow rate) in the power plant. The ionic liquid electrospray method combines the ideal solvent properties of ionic liquids with electrospray's ability to create a highly charged, high surface area solvating mist. Additionally, the ionic liquid electrospray method affords high capture efficiency, a wide operating range, low power consumption, and a small footprint.

### Ionic Liquids

Ionic liquids suitable for use as disclosed herein can, in principle, be any ionic liquid that absorbs carbon dioxide; however, ionic liquids that have minimal absorption of carbon dioxide will be less effective. Ideally, ionic liquids having high absorption of carbon dioxide are desired for efficient use as described herein. Additionally, mixtures of two or more ionic liquids may be used.

Many ionic liquids are formed by reacting a nitrogen-containing heterocyclic ring, preferably a heteroaromatic ring, with an alkylating agent (for example, an alkyl halide) to form a cation. Examples of suitable heteroaromatic rings include substituted pyridines and imidazoles. These rings can be alkylated with virtually any straight, branched or cyclic C₁₋₂₀ alkyl group, but preferably, the alkyl groups are C₁₋₁₆ groups. Various other cations such as ammonium, phosphonium, sulfonium, and guanidinium may also be used for this purpose. Ionic liquids suitable for use herein may also be synthesized by salt metathesis, by an acid-base neutralization reaction or by quaternizing a selected nitrogen-containing compound; or they may be obtained commercially from several companies such as Merck (Darmstadt, Germany), BASF (Mount Olive, N.J.), Fluka Chemical Corp. (Milwaukee, Wis.), and Sigma-Aldrich (St. Louis, Mo.). For example, the synthesis of many ionic liquids is described by Shiflett et al. (U.S. Patent Application Publication No. 2006/0197053, which is by this reference incorporated as a part hereof for all purposes).

Representative examples of ionic liquids suitable for use herein are included among those that are described in sources such as J. Chem. Tech. Biotechnol., 68:351-356 (1997); Chem. Ind., 68:249-263 (1996); J. Phys. Condensed Matter, 5: (supp 34B): δ99-8106 (1993); Chemical and Engineering News, Mar. 30, 1998, 32-37; J. Mater. Chem., 8:2627-2636 (1998); Chem. Rev., 99:2071-2084 (1999); and WO 05/113,702 (and references cited therein); and US 2004/0133058 and US 2008/0028777 (each of which is by this reference incorporated as a part hereof for all purposes). In one embodiment, a library, i.e., a combinatorial library, of ionic liquids may be prepared, for example, by preparing various alkyl derivatives of a quaternary ammonium cation, and varying the associated anions.

Ionic liquids suitable for use herein comprise an anion and a cation, the cation is selected from the group consisting of cations represented by the structures of the following formulae:

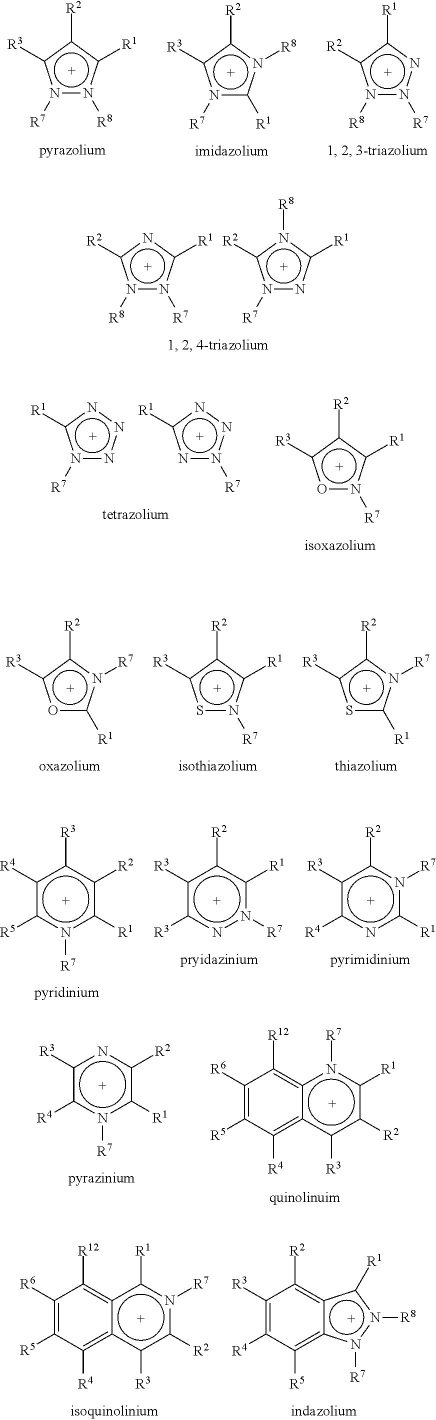

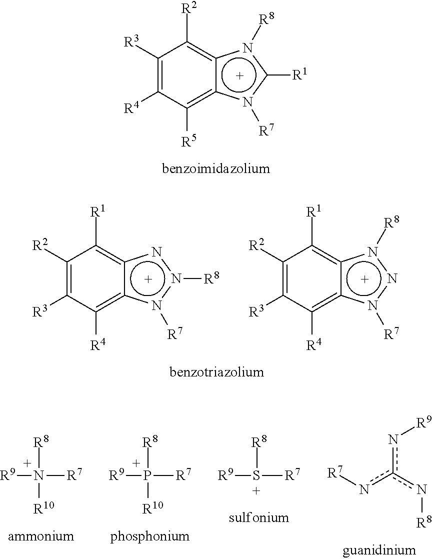

wherein:

a) R¹, R², R³, R⁴, R⁵, R⁶, and R¹² are independently selected from the group consisting of:
(i) H,
(ii) halogen such as Cl, Br, F, I,
(iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to C₂₀ unsubstituted aryl, or C₆ to C₂₅ unsubstituted heteroaryl having one to three heteroatoms independently selected from the group consisting of O, N, Si and S;
(vi) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (A) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
   (B) OH,
   (C)NH₂, and
   (D) SH;
(vii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
(viii)

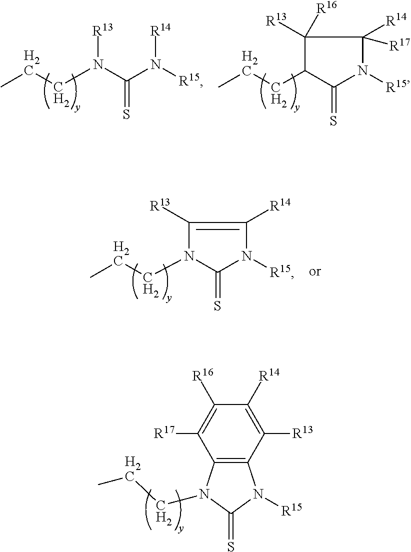

wherein y is 0-15, and R¹³, R¹⁴, R¹⁵, R¹⁶, and R¹⁷ are independently selected from the group consisting of: (i), (iii), (iv), (v), (vi) and (vii) as set forth above;

b) R⁷, R⁸, R⁹, and R¹⁰ are independently selected from the group consisting of:
(ix) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(x) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(xi) C₆ to C₂₅ unsubstituted aryl, or C₆ to C₂₅ unsubstituted heteroaryl having one to three heteroatoms independently selected from the group consisting of O, N, Si and S; and
(xii) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (E) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
   (F) OH,
   (G) NH₂, and
   (H)SH;
(xiii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
(xiv)

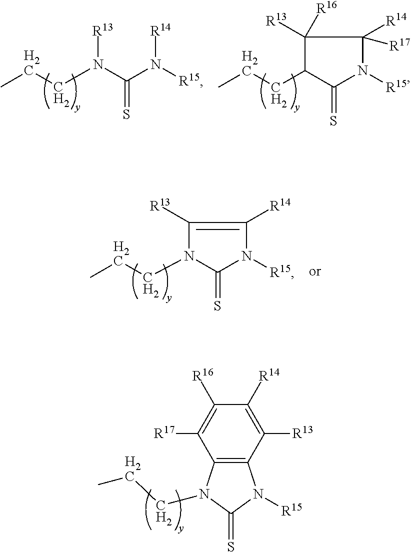

wherein y is 0-15, and R¹³, R¹⁴, R¹⁵, R¹⁶, and R¹⁷ are independently selected from the group consisting of: (i), (iii), (iv), (v), (vi) and (vii) as set forth above; and

c) optionally at least two of R¹, R², R³, R⁴, R⁵, R⁶, R⁷, R⁸, R⁹, and R¹⁰ can together form a cyclic or bicyclic alkanyl or alkenyl group.

In one embodiment, the ionic liquid comprises an anion selected from one or more members of the group consisting of: [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CuCl₂]⁻, Cl⁻, Br⁻, I⁻, SCN⁻, and a fluorinated anion.

In one embodiment, the ionic liquid comprises a cation selected from one or more members of the group consisting of pyridinium, pyridazinium, pyrimidinium, pyrazinium, imidazolium, pyrazolium, thiazolium, oxazolium, triazolium, phosphonium, ammonium, and guanidinium.

In another embodiment, the ionic liquid comprises an anion selected from one or more members of the group consisting of acetate, aminoacetate, ascorbate, benzoate, catecholate, citrate, dialkylphosphate, formate, fumarate, gallate, glycolate, glyoxylate, iminodiacetate, isobutyrate, kojate, lactate, levulinate, oxalate, pivalate, propionate, pyruvate, salicylate, succinamate, succinate, tiglate, tetrafluoroborate, tetrafluoroethanesulfonate, tropolonate, [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]₋, [(CF₃CFHCF₂SO₂)₂N]⁻, F⁻, and anions represented by the structure of the following formula:

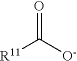

wherein R¹¹ is selected from the group consisting of:
(i) —CH₃, —C₂H₅, or C₃ to C₁₇ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₁₇ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₁₀ unsubstituted aryl, or C₆ to C₁₇ unsubstituted heteroaryl having one to three heteroatoms independently selected from the group consisting of O, N, Si and S; and
(iv) C₆ to C₁₀ substituted aryl, or C₆ to C₁₇ substituted heteroaryl having one to three heteroatoms independently selected from the group consisting of O, N, Si and S; and wherein said substituted aryl or substituted heteroaryl has one to three substituents independently selected from the group consisting of:
   (A) —CH₃, —C₂H₅, or C₃ to C₁₇ straight-chain, branched or cyclic alkane or alkene, optionally substituted with at least one member selected from the group consisting of Cl, Br, F, I, OH, NH₂ and SH,
   (B) OH,
   (C)NH₂, and
   (D) SH.

Particularly suitable ionic liquids for carbon dioxide and/or sulfur dioxide capture in the method disclosed herein are ionic liquids where at least one R-group substituent on the cation contains a thiourea, dihydrothioimidazole or thioimidazole. These thio-containing ionic liquids can be generically represented as the following four structures:

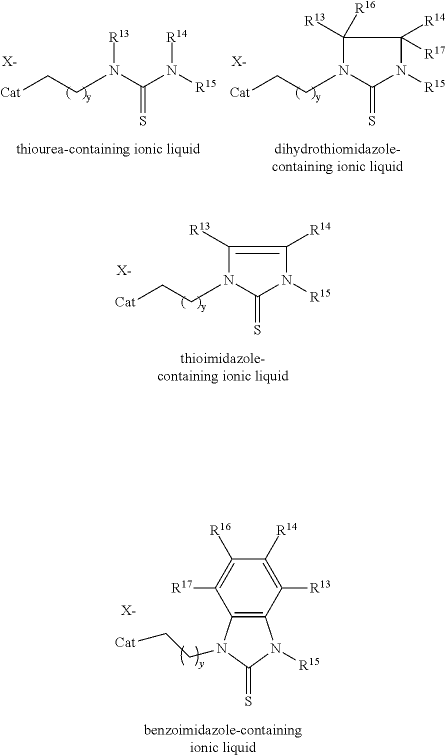

wherein “Cat” represents any of the cations listed above, X— represents any of the anions listed above, y is 0-15, and R¹³, R¹⁴, R¹⁵, R¹⁶, and R¹⁷ are independently selected from the group consisting of:
(a) H,
(b) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(c) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(d) C₆ to C₂₀ unsubstituted aryl, or C₆ to C₂₅ unsubstituted heteroaryl having one to three heteroatoms independently selected from the group consisting of O, N, Si and S;
(e) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
   (A) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH,
   (B) OH,
   (C)NH₂, and
   (D) SH; and
(f) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4.

These ionic liquids may by prepared, for example, from the amine-containing “task specific ionic liquids” (TSIL) described by Gutowski et al. (J. Am. Chem. Soc. 130:14690-14704, 2008) and Davis et al. (WO 2008/122030), and isothiocyanates according to the following reaction scheme:

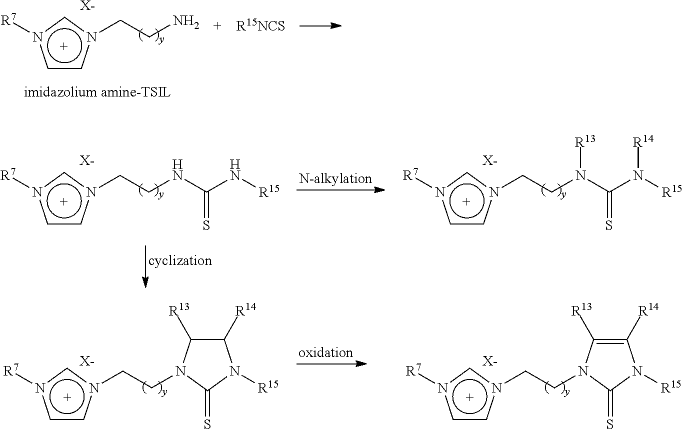

wherein X— represents any of the anions listed above, y is 0-15, and R⁷, R¹³, R¹⁴, and R¹⁵ are defined above. The thiourea ionic liquid adducts may be converted into heterocyclic thiones by cyclization.

A TSIL consisting of an immidazolium ion to which a primary amine moiety is covalently tethered was prepared by a process described in Bates et al, Volume 124, No. 6, 2002, Journal of the American Chemical Society, pages 926927 as follows: “The cation core is assembled by the reaction of 1-butylimidazole with 2-bromopropylamine hydrobromide in ethanol. After 24 hours under reflux, the ethanol is removed in vacuo, and the solid residue dissolved in a minimal quantity of water that is brought to ˜pH 8 by the addition, in small portions, of solid KOH. The product imidazolium bromide is then separated from the KBr byproduct by evaporation of the water, followed by extraction of the residue with ethanol-THF, in which the immidazolium salt is soluble. Subsequent ion-exchange with NaBF₄ in ethanol/water gives the product salt in 58% overall yield.”

### Additives to Enhance CO₂ Absorption by Ionic Liquids

Various additives may be used to enhance the absorption of CO₂ by ionic liquids. For example, neutral sulfur-based reagents, such as thioureas, thiones, and related compounds, may be used as CO₂ absorbent additives to ionic liquids. Various mixtures of these compounds may also be used. These compounds, while being potent nucleophiles, are less basic than amines, and generate a zwitterionic thiocarbonate upon reaction with CO₂ that could be reversed upon heating.

Suitable thioureas, imidazole thiones and benzoimidazole thiones are represented by the general structures:

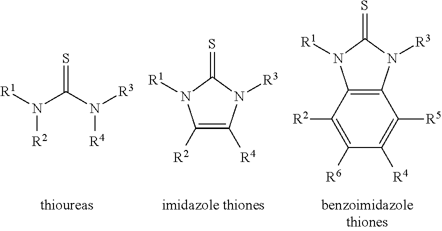

wherein R¹, R², R³, R⁴, R⁵, and R⁶ are defined above.

The driving force for the capture reaction, the temperature needed to reverse depends, and the solubility of these species in ionic liquids involve the R group substituents on the nitrogen. Furthermore, the non-bonding ionic interaction between the cation and anion in the ionic liquid or other additives present and the zwitterionic carbonates are involved in the overall thermodynamics of this chemistry.

In one embodiment for the thioureas, R¹ is an electron rich aryl group, R² is a C₁˜C₁₀, C₁˜C₈, C₁˜C₆, alkyl group, R³ is H or an electron withdrawing group, and R⁴ is a long chain (C₂˜C₂₀) alkyl group.

In another embodiment for the imidazole thiones and the benzoimidazole thiones, R¹ is an electron rich (e.g. negatively charged) aryl group, R³ is H or an electron withdrawing group (electron deficient e.g. positively charged), and R² and R⁴, R⁵, and R⁶ are independently H, an alkyl group, or an aryl group.

Substituted thioureas may be prepared using the method described by Neville et al. (Org. Syn. Coll. 5:801, 1973). For example, a solution of cyclohexylamine in anhydrous benzene is added to silicon tetraisocyanate in anhydrous benzene. The mixture is heated and the benzene is removed; isopropyl alcohol is added to the residue, and the mixture is heated and filtered.

1,3-dialkylimidazole-2-thiones and benzoimidazole thiones may be prepared by thionation of imidazolium halides, as described by Benac et al. (Org. Syn. Coll. 7:195, 1990). For example, 1,3-dimethylimidazolium iodide, anhydrous potassium carbonate, sulfur and methanol are combined. The mixture is stirred, filtered, washed with dichloromethane and dried.

### Electrospray

Electrospray can be generated by applying an electric field (e.g., about 10 V/cm to about 1000 V/cm) between a conductive liquid and a counter electrode, as described by Gu et al. (U.S. Patent Application Publication No. 2009/0235817, which is by this reference incorporated as a part hereof for all purposes). When the conductive liquid is housed in a small (e.g., 0.1 mm) electrospray nozzle, the intense electrical field accumulates a high number of charges on the liquid meniscus formed at the nozzle tip. The electrostatic attraction between this high charge density meniscus and the counter electrode exerts a strong force on the meniscus. When this force exceeds the surface tension of the liquid, highly charged droplets break off from the meniscus. The droplet's high net charge results in its hydrodynamic instability, causing the primary droplet to break up into many secondary smaller nanodroplets via Coulomb repulsion. This process generates a high surface area (e.g., 1000 m²/g) spray plume. The highly charged nanodroplets travel toward and ultimately discharge at the counter electrode. This is created by a low current (microamp) flowing between the spray nozzle and the counter electrode. However, a high voltage level is required. The typical power consumption is approximately 1 W/1000 m³ h or about 3 orders of magnitude lower than conventional technologies (3 to 5 kW/1000 m³ h).

As all of the droplets are of the same charge, similar repulsion forces are responsible for the mist expanding in a hyperbolic cone, referred to herein as an electrospray plume. The electric field may be a DC electric field or an AC electric field. Although electrode localized oxidative/reductive reactions have been observed after hours of DC spraying, they may be effectively prevented by using an AC source. In one embodiment, an AC electric field is used to drive the electrospray. As the switching of the polarity of the electric field is transient, recombination of the positively and negatively charged droplets generated during each polarity phase have little effect on the capturing efficiency of the ionic liquid electrospray disclosed herein. The highly charged, high surface area electrospray plumes may be useful for capturing carbon dioxide emissions from flue gas.

### Method for Capturing Carbon Dioxide

The method disclosed herein for capturing carbon dioxide from flue gas comprises the following steps. The first step is to provide a sample of flue gas comprising carbon dioxide, for example from a coal-fired power plant. The flue gas exiting the boiler of the plant may be passed through an electrostatic precipitator, such as that described by Richards (U.S. Pat. No. 4,095,962, which is by this reference incorporated as a part hereof for all purposes), to remove particulates. The flue gas may also be passed through a desulfurization system to remove sulfur dioxide. Alternatively, the ionic liquid electrospray may be used to capture both sulfur dioxide and carbon dioxide, as described below. In one embodiment, the flue gas is compressed to a pressure of about 0.1 MPa to about 1 MPa and cooled by passage through a heat exchanger.

In the next step, an ionic liquid electrospray plume comprising nanodroplets of at least one ionic liquid is formed by passing the ionic liquid through an electrospray nozzle and applying an electric field between the electrospray nozzle and a counter electrode. The ionic liquid may be any of those described above, including mixtures of two or more ionic liquids. The ionic liquid may comprise at least one additive to enhance carbon dioxide absorption, as described above. The ionic liquid electrospray plume may be formed using a DC or AC electric field having a field strength of about 10 V/cm to about 1000 V/cm. For the AC electric field, a frequency of about 0.1 Hz to about 100 Hz may be used. The electrospray plume may be formed using a system such as that described by Gu et al., supra.

Then, the flue gas is exposed to the ionic liquid electrospray plume, whereby at least a portion of the carbon dioxide is absorbed by the nanodroplets of the ionic liquid. In one embodiment, at least 90% of the carbon dioxide originally present in the flue gas is absorbed by the ionic liquid nanodroplets. In another embodiment, the carbon dioxide in the flue gas is reduced to about 1.3 vol % after exposure to the ionic liquid nanodroplets. In one embodiment, the flue gas is exposed to the ionic liquid electrospray plume in an absorption column in which the ionic liquid nanodroplets flow countercurrent to the flue gas. In one embodiment, the ionic liquid is cooled using refrigeration to a temperature of about 273° K to about 313° K before exposure to the flue gas.

The nanodroplets of the ionic liquid containing the absorbed carbon dioxide are collected on the counter electrode. The carbon dioxide captured in the ionic liquid may be recovered and the ionic liquid regenerated in various ways. For example, the ionic liquid containing the absorbed carbon dioxide may be heated in a stripping column to release the carbon dioxide and regenerate the ionic liquid. In one embodiment, the ionic liquid containing the absorbed carbon dioxide is regenerated using a flash technique in which the pressure is reduced and the ionic liquid is heated to release the absorbed carbon dioxide. In another embodiment, the ionic liquid containing the absorbed carbon dioxide may be regenerated by applying an electric field to the ionic liquid. The application of an electric field changes the inherent structure of the ionic liquid (Wang, J. Phys. Chem. B, 113:11058-11060, 2009), thereby releasing the absorbed carbon dioxide from the intermolecular free volume of the ionic liquid (Shi et al. J. Phys. Chem. B, 112:29045-2055, 2008, and J. Phys. Chem. B, 112:16710-16720, 2008). The released carbon dioxide may be liquefied by pressurizing for storage.

As noted above, the method disclosed herein may be used to capture both carbon dioxide and sulfur dioxide. This would provide the most energy efficient process. In this embodiment, an ionic liquid is selected that absorbs both gases, for example an ionic liquid comprising a sulfur-containing group such as those described above. Each gas may be separately released from the ionic liquid by using different temperatures in the regeneration step, thereby taking advantage of the different strength of the S—C and S—S bonds. Alternatively, the sulfur dioxide and carbon dioxide may be separated using methods known in the art, such as that described by Confuroto (Hydrocarbon Eng. 5:28-32, 2000).

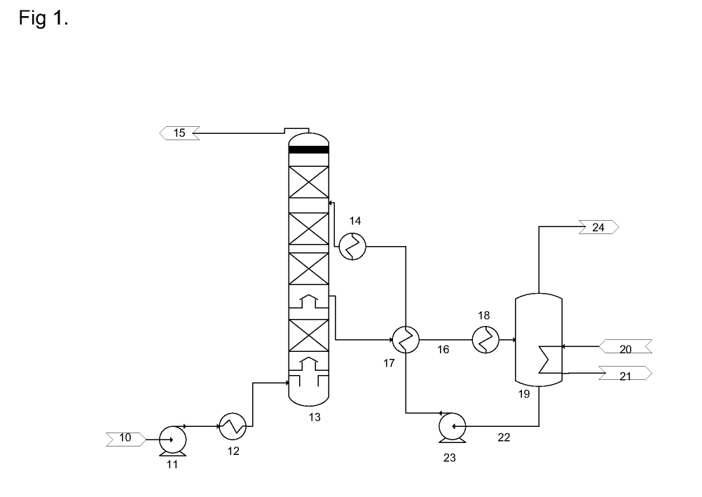

An exemplary system for carrying out one embodiment of the method disclosed herein for capturing carbon dioxide from flue gas using ionic liquid electrospray is shown in FIG. 1. Referring to FIG. 1, the flue gas from the power plant 10 is compressed by passage through compressor 11 and then cooled by a prechiller 12. The compressed and cooled flue gas enters the bottom of absorption column 13, wherein it is exposed to the ionic liquid electrospray plume, which is formed by passing the ionic liquid through an electrospray nozzle (not shown). An electric field is applied between the electrospray nozzle and a counter electrode, which may be a plate or a series of plates (not shown) in the absorption column. Additionally, the counter electrode may be the wall of the absorption column. The ionic liquid may be injected into the absorption column through a series of electrospray nozzles (not shown) positioned around the circumference of the absorption column. The ionic liquid is cooled by precooler 14 before entry into the absorption column 13. The treated flue gas 15 is vented from the top of the absorption column 13. The ionic liquid containing the absorbed carbon dioxide 16 is collected on the counter electrode and exits the absorption column 13 and enters a process heat exchanger 17. Next, the ionic liquid passes through a flash preheater 18 and enters flash tank 19. The flash tank is essentially a simple single stage stripper where the ionic liquid containing absorbed carbon dioxide is regenerated by heating with steam 20. The condensate from the steam 21 exits the flash tank 19 and may be heated to regenerate the steam. The regenerated ionic liquid 22 exits the bottom of the flash tank 19 and is pumped by recycle pump 23 back through the process heat exchanger 17 and cooled before entering the absorption column 13 through the electrospray nozzle(s) (not shown). Due to the very low vapor pressure of the ionic liquid, the flash tank vapor is assumed to contain only carbon dioxide 24 and a condenser is not required. The carbon dioxide 24 exiting the flash tank 19 may be collected and liquefied by pressurizing for storage.

### EXAMPLES

The present invention is further illustrated in the following example. It should be understood that this example, while indicating preferred embodiments of the invention, are given by way of illustration only. From the above discussion and this example, one skilled in the art can ascertain the essential characteristics of this invention, and without departing from the spirit and scope thereof, can make various changes and modifications of the invention to adapt it to various uses and conditions.

The meaning of abbreviations used is as follows: “vol %” means percent by volume, “mm” means millimeter(s), “nm” means nanometer(s), “V” means volt(s).

### Example 1 (Prophetic)

### Capture of Carbon Dioxide from Synthetic Flue Gas Using Ionic Liquid Electrospray

This prophetic example describes a method for capturing carbon dioxide from a synthetic flue gas stream using an electrospray of the ionic liquid 1-butyl-3-methylimidazolium acetate.

The test procedure is divided into three stages. A mass spectrometer is used to monitor carbon dioxide in a synthetic flue gas stream containing 14 vol % CO₂ and 86 vol % N2. In stage 1, a baseline for 100% CO₂ capture is established by measuring the signal area of the mass spectrum obtained in the presence of pure nitrogen. In stage 2, 0% CO₂ capturing efficiency is evaluated by measuring the signal area of the mass spectrum obtained in the presence of pure carbon dioxide. In stage 3, the actual CO₂ capture efficiency of the ionic liquid electrospray is evaluated using the synthetic flue gas. The ionic liquid, 1-butyl-3-methylimidazolium acetate, is introduced into a spray column through a nozzle (0.1 to 1 mm diameter) connected to a voltage generator (0 to 100 V). The electrospray generates nanometer size droplets of the ionic liquid (100 to 1000 nm). The synthetic flue gas flows counter current to the nanodroplets where CO₂ is absorbed from the flue gas into the ionic liquid. The CO₂ capture efficiency of the ionic liquid electrospray is evaluated by measuring the signal area of the mass spectrum obtained in the presence of the treated synthetic flue gas.

Various materials suitable for use herein may be made by processes known in the art, and/or are available commercially from suppliers such as Alfa Aesar (Ward Hill, Mass.), City Chemical (West Haven, Conn.), Fisher Scientific (Fairlawn, N.J.), Sigma-Aldrich (St. Louis, Mo.) or Stanford Materials (Aliso Viejo, Calif.).

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

In the various embodiments of this invention, an ionic compound formed by selecting any of the individual cations described or disclosed herein, and by selecting any of the individual anions described or disclosed herein, may be used for the purposes hereof. Correspondingly, in yet other embodiments, a subgroup of ionic liquids formed by selecting (i) a subgroup of any size of cations, taken from the total group of cations described and disclosed herein in all the various different combinations of the individual members of that total group, and (ii) a subgroup of any size of anions, taken from the total group of anions described and disclosed herein in all the various different combinations of the individual members of that total group, may be used for the purposes hereof. In forming an ionic compound, or a subgroup of ionic compounds, by making selections as aforesaid, the ionic compound or subgroup will be identified by, and used in, the absence of the members of the group of cations and/or the group of anions that are omitted from the total group thereof to make the selection; and, if desirable, the selection may thus be made in terms of the members of one or both of the total groups that are omitted from use rather than the members of the group(s) that are included for use.

Each of the formulae shown herein describes each and all of the separate, individual compounds and compositions that can be assembled in that formula by (1) selection from within the prescribed range for one of the variable radicals, substituents or numerical coefficents while all of the other variable radicals, substituents or numerical coefficents are held constant, and (2) performing in turn the same selection from within the prescribed range for each of the other variable radicals, substituents or numerical coefficents with the others being held constant. In addition to a selection made within the prescribed range for any of the variable radicals, substituents or numerical coefficents of only one of the members of the group described by the range, a plurality of compounds and compositions may be described by selecting more than one but less than all of the members of the whole group of radicals, substituents or numerical coefficents. When the selection made within the prescribed range for any of the variable radicals, substituents or numerical coefficents is a subgroup containing (i) only one of the members of the whole group described by the range, or (ii) more than one but less than all of the members of the whole group, the selected member(s) are selected by omitting those member(s) of the whole group that are not selected to form the subgroup. The compound, composition or plurality of compounds or compositions, may in such event be characterized by a definition of one or more of the variable radicals, substituents or numerical coefficents that refers to the whole group of the prescribed range for that variable but where the member(s) omitted to form the subgroup are absent from the whole group.

Other related systems, materials and methods for the removal of CO₂ or SO₂ from a gaseous mixture are disclosed in the following concurrently-filed U.S. provisional patent applications:

61/313,298, 61/414,532, 61/416,421; 61/313,173;
61/313,181; 61/313,322; 61/313,328;
61/313,312; 61/313,183; and 61/313,191;

each of which is by this reference incorporated in its entirety as a part hereof for all purposes.

What is claimed is:

1. A method for capturing carbon dioxide and/or sulfur dioxide from a gaseous mixture comprising the steps of:
a) providing a gaseous mixture comprising carbon dioxide and/or sulfur dioxide;
b) forming an ionic liquid electrospray plume comprising nanodroplets of at least one ionic liquid by
passing the ionic liquid through an electrospray nozzle and applying an electric field between the electrospray nozzle and a counter electrode;
c) exposing the gaseous mixture to the ionic liquid electrospray plume, whereby at least a portion of the carbon dioxide and/or sulfur dioxide is absorbed by the nanodroplets of the ionic liquid; and
d) collecting the nanodroplets of the ionic liquid containing absorbed carbon dioxide and/or sulfur dioxide on the counter electrode;
wherein said ionic liquid comprises an anion and a cation, said cation is selected from the group consisting of cations represented by the structures of the following formulae: 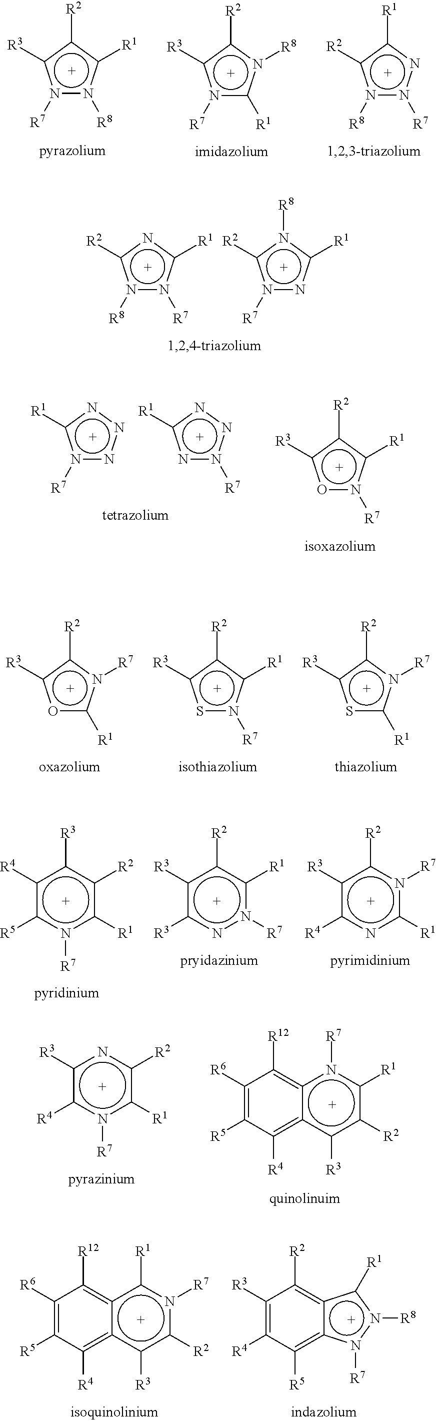 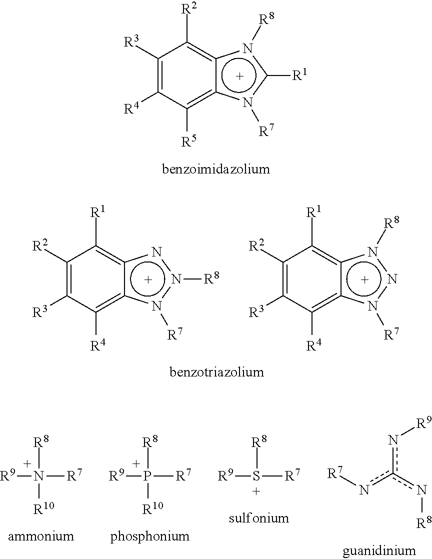
wherein:
a) R¹, R², R³, R⁴, R⁵, R⁶, and R¹² are independently selected from the group consisting of:
(i) H,
(ii) halogen,
(iii) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(iv) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(v) C₆ to C₂₀ unsubstituted aryl, or C₆ to C₂₅ unsubstituted heteroaryl having one to three heteroatoms independently selected from the group consisting of O, N, Si and S;
(vi) C₆ to C₂₅ substituted aryl, or C₆ to C₂₅ substituted heteroaryl having one to three heteroatoms independently selected from the group consisting of O, N, Si and S; and wherein said substituted aryl or substituted heteroaryl has one to three substituents independently selected from the group consisting of:
(A) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
(B) OH,
(C)NH₂, and
(D) SH;
(vii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
(viii) 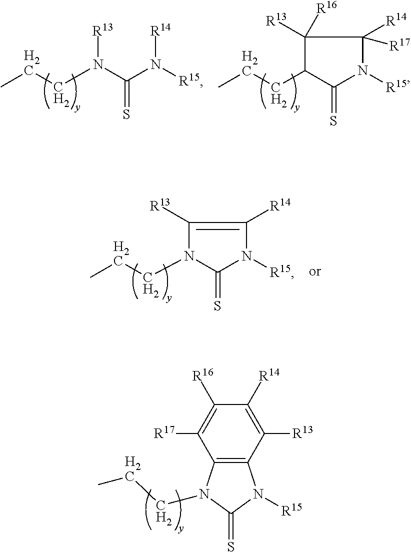
wherein y is 0-15, and R¹³, R¹⁴, R¹⁵, R¹⁶, and R¹⁷ are independently selected from the group consisting of: (i), (iii), (iv), (v), (vi) and (vii) as set forth above;
b) R⁷, R⁸, R⁹, and R¹⁰ are independently selected from the group consisting of:
(ix) —CH₃, —C₂H₅, or C₃ to C₂₅ straight-chain, branched or cyclic alkane or alkene, optionally substituted with at least one member selected from the group consisting of Cl, Br, F, I, OH, NH₂ and SH;
(x) —CH₃, —C₂H₅, or C₃ to C₂₅ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(xi) C₆ to C₂₅ unsubstituted aryl, or C₆ to C₂₅ unsubstituted heteroaryl having one to three heteroatoms independently selected from the group consisting of O, N, Si and S; and
(xii) C₆ to C₂₅ substituted aryl, or C₆ to C₂₅ substituted heteroaryl having one to three heteroatoms independently selected from the group consisting of O, N, Si and S; and
wherein said substituted aryl or substituted heteroaryl has one to three substituents independently selected from the group consisting of:
(E) —CH₃, —C₂H₅, or C₁ to C₂₅ straight-chain, branched or cyclic alkane or alkene, optionally substituted with at least one member selected from the group consisting of Cl, Br, F, I, OH, NH₂ and SH,
(F) OH,
(G) NH₂, and
(H)SH;
(xiii) —(CH₂)ₙSi(CH₂)ₘCH₃, —(CH₂)ₙSi(CH₃)₃, or —(CH₂)ₙOSi(CH₃)ₘ, where n is independently 1-4 and m is independently 0-4; and
(xiv) 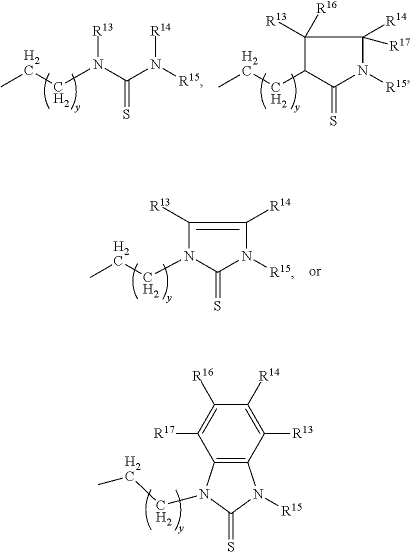
wherein y is 0-15, and R¹³, R¹⁴, R¹⁵, R¹⁶, and R¹⁷ are independently selected from the group consisting of: (i), (iii), (iv), (v), (vi) and (vii) as set forth above; and
c) optionally at least two of R¹, R², R³, R⁴, R⁵, R⁶, R⁷, R⁸, R⁹, and R¹⁰ can together form a cyclic or bicyclic alkanyl or alkenyl group.

2. The method according to claim 1 wherein the anion is selected from one or more members of the group consisting of: [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₃]³⁻, [HPO₃]²⁻, [H₂PO₃]¹⁻, [PO₄]³⁻, [HPO₄]²⁻, [H₂PO₄]⁻, [HSO₃]⁻, [CuCl₂]⁻, Cl⁻, Br⁻, I⁻, SCN⁻, and a fluorinated anion.

3. The method according to claim 1 wherein the cation is selected from one or more members of the group consisting of pyridinium, pyridazinium, pyrimidinium, pyrazinium, imidazolium, pyrazolium, thiazolium, oxazolium, triazolium, phosphonium, ammonium, and guanidinium.

4. The method according to claim 1 wherein the anion is selected from one or more members of the group consisting of acetate, aminoacetate, ascorbate, benzoate, catecholate, citrate, dialkylphosphate, formate, fumarate, gallate, glycolate, glyoxylate, iminodiacetate, isobutyrate, kojate, lactate, levulinate, oxalate, pivalate, propionate, pyruvate, salicylate, succinamate, succinate, tiglate, tetrafluoroborate, tetrafluoroethanesulfonate, tropolonate, [CH₃CO₂]⁻, [HSO₄]⁻, [CH₃OSO₃]⁻, [C₂H₅OSO₃]⁻, [AlCl₄]⁻, [CO₃]⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, [CuCl₂]⁻, Cl⁻, Br⁻, I⁻, SCN⁻, [BF₄]⁻, [PF₆]⁻, [SbF₆], [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂], [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃], [CF₃CF₂OCF₂CF₂SO₃], [(CF₂HCF₂SO₂)₂N]₋, [(CF₃CFHCF₂SO₂)₂N]⁻, F⁻, and anions represented by the structure of the following formula: 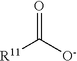
wherein R¹¹ is selected from the group consisting of:
(i) —CH₃, —C₂H₅, or C₃ to C₁₇ straight-chain, branched or cyclic alkane or alkene, optionally substituted with at least one member selected from the group consisting of Cl, Br, F, I, OH, NH₂ and SH;
(ii) —CH₃, —C₂H₅, or C₃ to C₁₇ straight-chain, branched or cyclic alkane or alkene comprising one to three heteroatoms selected from the group consisting of O, N, Si and S, and optionally substituted with at least one member selected from the group consisting of Cl, Br, F, I, OH, NH₂ and SH;
(iii) C₆ to C₁₀ unsubstituted aryl, or C₆ to C₁₇ unsubstituted heteroaryl having one to three heteroatoms independently selected from the group consisting of O, N, Si and S; and
(iv) C₆ to C₁₀ substituted aryl, or C₆ to C₁₇ substituted heteroaryl having one to three heteroatoms independently selected from the group consisting of O, N, Si and S; and wherein said substituted aryl or substituted heteroaryl has one to three substituents independently selected from the group consisting of:
(A) —CH₃, —C₂H₅, or C₁ to C₁₇ straight-chain, branched or cyclic alkane or alkene, optionally substituted with at least one member selected from the group consisting of Cl, Br, F, I, OH, NH₂ and SH,
(B) OH,
(C)NH₂, and
(D) SH.

5. The method according to claim 1 wherein the ionic liquid comprises at least one R group selected from the group consisting of:

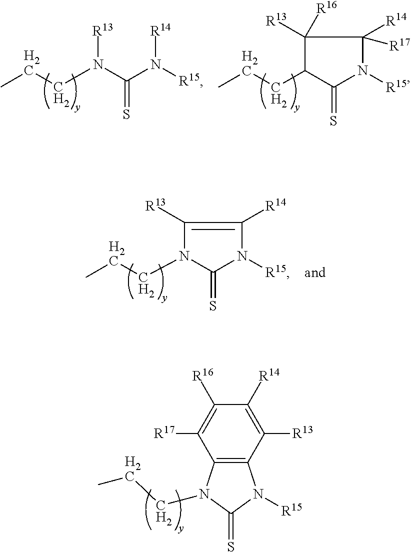

6. The method according to claim 1 wherein the ionic liquid comprises at least one additive selected from the group consisting of: 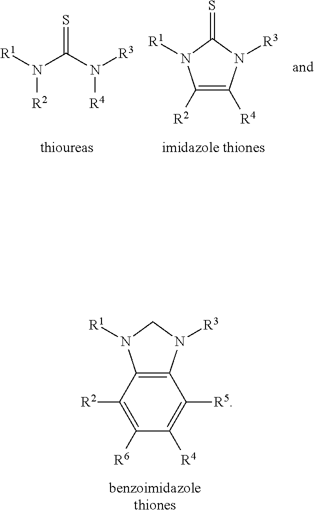
wherein R¹˜R⁶ are defined as in claim 1.

7. The method according to claim 1 wherein the electric field is a DC electric field.

8. The method according to claim 7 wherein the DC electric field has a field strength of about 10 V/cm to about 1000 V/cm.

9. The method according to claim 1 wherein the electric field is an AC electric field.

10. The method according to claim 9 wherein the AC electric field has a field strength of about 10 V/cm to about 1000 V/cm and a frequency of about 0.1 Hz to about 100 Hz.
